(19) United States
(12) Patent Application Publication
(10) Pub. No.: US 2025/0251955 A1
(43) Pub. Date: Aug. 7, 2025

(54) METHOD AND APPARATUS FOR MANAGING USER INTERFACE (UI) ON ELECTRONIC DEVICE

(71) Applicant: Samsung Electronics Co., Ltd., Suwon-si (KR)

(72) Inventors: Prabhat LAMBA, Bangalore (IN); Ravi Sankar GUNTUR, Bangalore (IN); Irfan ABDUL, Bangalore (IN)

(21) Appl. No.: 19/189,787

(22) Filed: Apr. 25, 2025

Related U.S. Application Data
(63) Continuation of application No. PCT/KR2023/000251, filed on Jan. 5, 2023.

(30) Foreign Application Priority Data
Nov. 18, 2022 (KR) 202241066269

(51) Int. Cl. G06F 9/451; G06F 3/0488

(52) U.S. Cl. CPC G06F 9/451; G06F 3/0488

(57) ABSTRACT

A method for managing a user interface (UI) comprises: determining total number of UI objects on a screen of an electronic device, an area covered by each of the UI objects, and a total area covered by the UI objects; obtaining a screen complexity level based on the determination; obtaining a frequency of occurrence of an error while performing at least one user operation on at least one of the UI objects; estimating a size of a fingertip of a user used for operation on one or more of the UI objects; determining a difficulty level for operating the at least one of the UI objects based on the screen complexity level, the frequency of occurrence of an error, and the size of the fingertip of the user; and rendering one or more UI screens with at least one modified UI object based on the determined difficulty level.

### CROSS-REFERENCE TO RELATED APPLICATIONS

This application is a continuation of International Application No. PCT/KR 2023/000251 designating the United States, filed on Jan. 5, 2023, in the Korean Intellectual Property Receiving Office and claiming priority to Indian Patent Application number 202241066269, filed on Nov. 18, 2022, in the Indian Patent Office, the disclosures of each of which are incorporated by reference herein in their entireties.

### BACKGROUND

### Field

The disclosure relates to managing a user interface (UI) operability on an electronic device. For example, the disclosure relates to a method and an apparatus for enhancing UI operability of an electronic device.

### Description of Related Art

An important part of the design for electronic display devices is their ease while the electronic device is being operated. With advancements in technology, the electronic display devices are becoming more compact and energy efficient. However, the downside of it is that users get smaller size display screens for operation. The smaller size of the electronic device display screen makes Human-Computer interaction difficult. Also, users with disabilities may face more problems due to complexities present in the small-size display screen. For example, a display screen becomes very dense, if the number of objects increases. Due to the dense screen, the user with disabilities may face a problem in clicking an object that the user wants to open. In another problem, a user with a fat finger is trying to open an object present on the display screen. But the user with the fat finger faces a problem while opening because the object on the screen is very small in size.

FIG. 1 is a diagram illustrating an example of a number of objects present on a small size display screen, as per the state-of-the-art solution. The user with the fat finger or with disabilities tries to open “Pay” icon. But, instead of the “Pay” object, another icon present on the display screen opens. The current technologies fail to provide a solution in such cases.

Therefore, there lies a need for a method and apparatus that can address various aforesaid issues.

### SUMMARY

According to an example embodiment of the present disclosure, a method for managing a user interface (UI) by an electronic device is disclosed. The method may comprise: determining a total number of UI objects on a screen of the electronic device, an area covered by each of the UI objects, and a total area covered by the UI objects; obtaining a screen complexity level based on the determination; obtaining a frequency of occurrence of an error while performing at least one user operation on at least one of the UI objects; estimating a size of a fingertip of a user used for operation on one or more of the UI objects; determining a difficulty level for operating the at least one of the UI objects based on the screen complexity level, the frequency of occurrence of an error, and the size of the fingertip of the user; and rendering on a display of the electronic device, one or more UI screens with at least one modified UI object based on the determined difficulty level.

According to an example embodiment of the present disclosure, an electronic device is disclosed. The electronic device may comprise: a memory; and at least one processor, comprising processing circuitry, coupled with memory, wherein at least one processor, individually and/or collectively, may be configured to: determine total number of UI objects on a screen of the electronic device, an area covered by each of the UI objects, and a total area covered by the UI objects; obtain a screen complexity level based on the determination; obtain a frequency of occurrence of an error while performing at least one user operation on at least one of the UI objects; estimate a size of a fingertip of a user used for operation on one or more of the UI objects; determine a difficulty level for operating the at least one of the UI objects based on the screen complexity level, the frequency of occurrence of an error, and the size of the fingertip of the user; and render on a display of the electronic device, one or more UI screens with at least one modified UI object based on the determined difficulty level

According to an example embodiment of the present disclosure, non-transitory computer-readable storage medium storing instructions is disclosed. The instructions, when executed by at least one processor, comprising processing circuitry, of an electronic device, individually and/or collectively, cause the electronic to perform operations comprising: determining total number of UI objects on a screen of the electronic device, an area covered by each of the UI objects, and a total area covered by the UI objects; obtaining a screen complexity level based on the determination; obtaining a frequency of occurrence of an error while performing at least one user operation on at least one of the UI objects; estimating a size of a fingertip of a user used for operation on one or more of the UI objects; determining a difficulty level for operating the at least one of the UI objects based on the screen complexity level, the frequency of occurrence of an error, and the size of the fingertip of the user; and rendering on a display of the electronic device, one or more UI screens with at least one modified UI object based on the determined difficulty level.

To further clarify the advantages and features of the present disclosure device, a more detailed description will be provided by reference various example embodiments thereof, which are illustrated in the appended drawings. It will be appreciated that these drawings depict example embodiments of the disclosure and are therefore not to be considered limiting its scope. The disclosure will be described and explained in greater detail below with reference to the accompanying drawings.

### BRIEF DESCRIPTION OF THE DRAWINGS

The above and other features, aspects, and advantages of certain embodiments of the present disclosure will be more apparent from the following detailed description, taken in conjunction with the accompanying drawings in which like characters represent like parts throughout the drawings, and in which:

FIG. 1 is a diagram illustrating a number of objects present on a small size display screen, as per the state-of-the-art solution;

FIG. 2 is a block diagram illustrating an example configuration of an electronic device for enhancing the operability of user interface (UI) of an electronic device, according to various embodiments;

FIG. 3 is a diagram illustrating an example system configuration for enhancing the operability of user interface (UI) screen of an electronic device, according to various embodiments;

FIG. 4A is a diagram illustrating an example of a clickable object score unit according to various embodiments;

FIG. 4B is a diagram illustrating an example scenario for calculating UI object's score according to various embodiments;

FIG. 5A is a diagram illustrating an example of a mean touch score unit according to various embodiments;

FIG. 5B is a diagram illustrating an example scenario for calculating a mean touch object score according to various embodiments;

FIG. 6A is a diagram illustrating an example of a screen density score unit according to various embodiments;

FIG. 6B is a diagram illustrating an example scenario for calculating a screen cluttered density score according to various embodiments;

FIG. 7A is a diagram illustrating an example of a screen complexity score unit according to various embodiments;

FIG. 7B is a diagram illustrating an example scenario for calculating a screen complexity score according to various embodiments;

FIG. 8 is a flowchart illustrating an example of user behavior according to various embodiments;

FIG. 9 is a diagram illustrating an example scenario for estimating user finger size according to various embodiments;

FIG. 10 is a flowchart illustrating example operations of an aggregator according to various embodiments; and

FIG. 11 is a flowchart illustrating example operations in the system for enhancing the operability of user interface (UI) of an electronic device according to various embodiments.

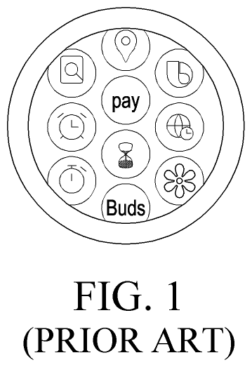

Further, skilled artisans will appreciate that elements in the drawings are illustrated for simplicity and may not have necessarily been drawn to scale. Furthermore, in terms of the construction of a device, one or more components of the device may have been represented in the drawings by conventional symbols, and the drawings may show those specific details that are pertinent to understanding the disclosure so as not to obscure the drawings with details that will be readily apparent to those of ordinary skill in the art having the benefit of the description herein.

### DETAILED DESCRIPTION

It should be understood at the outset that although illustrative implementations of various example embodiments of the present disclosure are illustrated below, the present disclosure may be implemented using any number of techniques, whether currently known or in existence. The present disclosure should in no way be limited to the illustrative implementations, drawings, and techniques illustrated below, including the example design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” may refer to “no embodiment, or one embodiment, or more than one embodiment, or all embodiments.”

The terminology and structure employed herein are for describing, teaching, and illuminating various example embodiments and their specific features and elements and do not limit, restrict, or reduce the spirit and scope of the claims or their equivalents.

For example, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does NOT preclude there being none of that feature or element unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skill in the art. Embodiments of the present disclosure will be described below in greater detail with reference to the accompanying drawings.

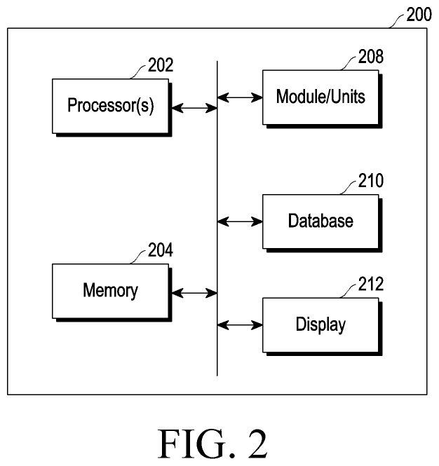

FIG. 2 is a block diagram illustrating an example configuration of an electronic device for enhancing operability of a user interface (UI) on the electronic device according to various embodiments. FIG. 2 illustrates an electronic device for enhancing the operability of the user interface (UI). The electronic device 200 includes one or more processor(s) (e.g., including processing circuitry) 202, a module/unit (e.g., including various circuitry and/or executable program instructions) 208, memory 204, a database 210, and a display 212 each of which are coupled with each other.

As an example, the electronic device 200 may correspond to various devices such as a personal digital assistant (PDA), a mobile device, smart watches, a touch screen device, a communications device, a computing device, or any other machine capable of executing a set of instructions.

In an example, the processor 202 may include various processing circuitry and may include a single processing unit or a number of units, all of which could include multiple computing units. The processor 202 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 202 is configured to fetch and execute computer-readable instructions and data stored in the memory 204. The processor 202 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The memory 204 may store instructions. When the instructions are executed by the processor 202, the instructions causes the electronic device perform operations described herein.

In an example, the module(s), engine(s), and/or unit (s) 208 may include a program, a subroutine, a portion of a program, a software component, or a hardware component capable of performing a stated task or function. As used herein, the module(s), engine(s), and/or unit (s) 208 may be implemented on a hardware component such as a server independently of other modules, or a module can exist with other modules on the same server, or within the same program. The module(s), engine(s), and/or unit (s) 208 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit (s) 208 when executed by the processor(s) 202 may be configured to perform any of the described functionalities. According to an embodiment of the present disclosure, the module(s), engine(s), and/or unit (s) 208 of the electronic device 200 may include a metric observer unit, user behavior unit, aggregator unit, and a UI recommender unit. According to an embodiment of the present disclosure, the metric observer unit further includes a clickable object score unit (Nₛ), a mean touch score unit (Eₛ), screen density score unit (Dₛ), and a screen complexity score unit (Cₛ).

As a further example, the database 210 may be implemented with integrated hardware and software. The hardware may include a hardware disk controller with programmable search capabilities or a software system running on general-purpose hardware. The examples of databases are, but not limited to, in-memory database, cloud database, distributed database, embedded database, and the like. The database, amongst other things, serves as a repository for storing data processed, received, and generated by one or more of the processors, and the modules/engines/units.

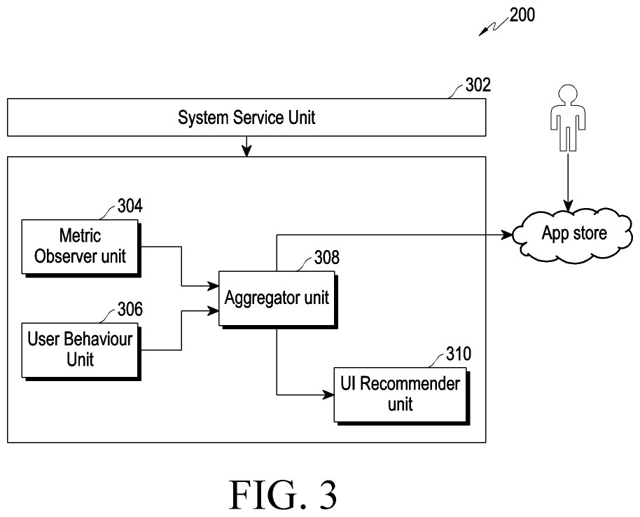

The modules/engines/units 208 may be implemented with an AI unit that may include a plurality of neural network layers. Examples of neural networks include, but are not limited to, convolutional neural network (CNN), deep neural network (DNN), recurrent neural network (RNN), and Restricted Boltzmann Machine (RBM). The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with AI may be performed through the non-volatile memory, the volatile memory, and the processor. The processor 202 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. A detailed explanation of each of the aforesaid components as shown in FIG. 3 will be explained in detail in the forthcoming paragraphs.

FIG. 3 is a block diagram illustrating an example configuration for enhancing operability of user interface (UI) of an electronic device according to various embodiments. Further, the reference numerals are kept same for the ease of explanation.

The present disclosure provides the electronic device 200 for calculating the difficulty level of operation and provides one or more UI screens with enhanced objects. According to an embodiment of the present disclosure, the electronic device 200 includes the metric observer unit 304, the user behavior unit 306, the aggregator unit 308, and the UI recommender unit 310, each of which may include various circuitry and/or executable program instructions as described above with reference to the modules/units of FIG. 2. The model/unit 208 as shown in FIG. 2 includes all the aforesaid units. Let us consider a scenario, where a user tries to click a UI object/icon from a number of objects/icons present on the UI screen of the electronic device. But the user is a fat finger user and faces difficulty while clicking the desired object/icon due to the complexity of the screen. The complexity of the UI screen may be due to a large number of clickable objects present on the UI screen or the clickable objects being very close to each other or the clickable object being very small in size, etc. A detailed working of each of the components of the electronic device 200 is explained in the forthcoming paragraphs.

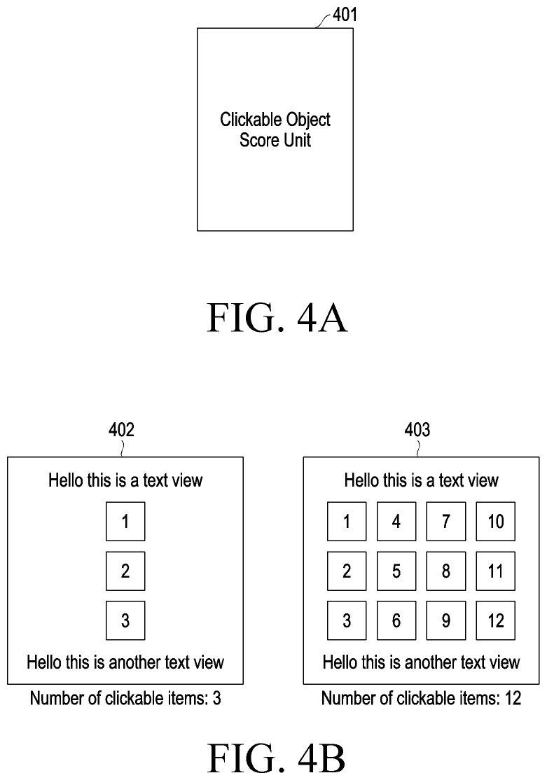

According to an embodiment of the present disclosure, the metric observer unit 304 may be configured to retrieve the information about the UI objects from a system service unit 302. The system service unit 302 provides information about a screen layout of the electronic device 200 on which the user is operating, user touch inputs like clicking or touching on the UI screen for selecting the UI objects, etc. After retrieving, the metric observer unit 304 further sends this information to the clickable object score unit (Nₛ), the mean touch score unit (Eₛ), and the screen density score unit (Dₛ) for calculating the complexity level of the UI screen. The complexity level of the screen is computed by the clickable object score unit (Nₛ), the mean touch score unit (Eₛ), and the screen density score unit (Dₛ). A detailed explanation for calculating the complexity level by each of the units is explained with the help of FIGS. 4-7 in the forthcoming paragraphs.

FIG. 4A is a diagram illustrating an example of the clickable object score unit according to various embodiments. In FIG. 4A, the clickable object score unit 401 may be configured to obtain an area (Aₛ) of the UI screen of the electronic device 200. The area (Aₛ) of the screen is predefined and is obtained from the database 210 of the system service unit 302. The clickable object score unit 401 may be configured to obtain a minimum size (Ai) value of a UI object present on the UI screen. Ai is a recommended minimum size of any given UI object based on types of the electronic device. The clickable object score unit 401 determines total number of UI objects that may be present on the screen. The total number of the UI objects is determined from given Equation 1 below:

$$Total Number of UI object = ( {A}_{s} ) / ( Ai ) \qquad Equation 1$$

where Ai is the recommended minimum size of a UI object,
Aₛ is the area of the UI screen.

The clickable object score unit 401 compares the total number of the UI objects with a predefined threshold value. The clickable object score unit 401 gives a score in a predefined scale range based on the total number of clickable objects present on the UI screen. Based on the score, a complexity level of the UI screen is assigned. In other words, the screen complexity is directly proportional to the number of UI objects present on the screen. If the number of UI objects is less than the predefined threshold value, it may refer, for example, to the screen being less complex. However, if the number of the UI objects is more than the predefined threshold value, it may refer, for example, to the screen being more complex. The threshold value is defined according to the device type.

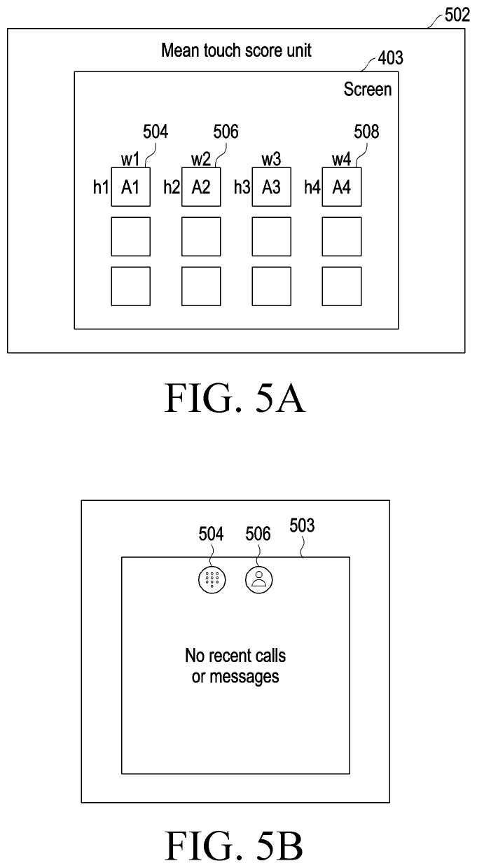

In a non-limiting example, as shown in FIG. 4B, is a diagram illustrating an example scenario for calculating UI objects score according to various embodiments. In FIG. 4B, there are two different UI screens, UI screen 402 and UI screen 403. The clickable object score unit 401 determines the total number of UI objects present on the UI screens 402 and 403 using Equation 1. On the UI screen 402 a total of “3 UI objects” are present. However, the UI screen 403 has a total of “12 UI objects”. After comparing with the predefined threshold value, the clickable object score unit 401 determines that the UI screen 403 may be more complex and assigns the score accordingly. The mean touch score unit (Eₛ) of the electronic device 200 as shown in FIG. 5A may calculate a mean touch target score. A detailed explanation of the mean touch score unit (Eₛ) is provided in greater detail below.

FIG. 5A is a diagram illustrating an example of the mean touch score unit according to various embodiments. The mean touch score unit (Eₛ) 502 may be configured to calculate area of each of the UI objects w.r.t to the area of the UI screen 403. For calculating the area of each of the UI object, the mean touch score unit 502 first obtains a height and width value of each of the UI objects from the system service unit 302. For example, in FIG. 5A, UI object 504 height is h1 and width is w1. Likewise, UI object 506 height is h2 and width is w2, and UI object 508 height is h4 and width is w4. The mean touch score unit 502 of the electronic device 200 calculates the area of each of the UI objects. So, the area of the UI object 504 is A1=h1*w1, UI object 506 is A2=h2*w2, and UI object 508 is A4=h4*w4.

The mean touch score unit 502 calculates a weighted Arithmetic mean for the width and height in the UI screen 403 for all of the UI objects present on the UI screen 403 by the given Equation 2.

$$\begin{matrix}\overline{width} = \frac{1}{{A}_{s}} {\sum }_{i = 1}^{N} {A}_{i} {w}_{i} \\ \overline{height} = \frac{1}{{A}_{s}} {\sum }_{i = 1}^{N} {A}_{i} {h}_{i}\end{matrix} \qquad Equation 2$$

$${E}_{s} = \frac{( 1 - \frac{\overline{width}}{{width}_{s}} ) + ( 1 - \frac{\overline{height}}{{height}_{s}} )}{2}$$

By calculating the weighted Arithmetic mean for all of the UI objects present on the UI screen 403, a level of emptiness on the UI screen 403 is determined. If the calculated weighted Arithmetic mean is less as compared to the area Aₛ of the UI screen 403, then it may be determined that the UI screen 403 is empty. The mean touch score unit 502 assigns scores in the range of 0 and 1, 1 being the more complex UI screen and vice-versa based on the UI screen emptiness.

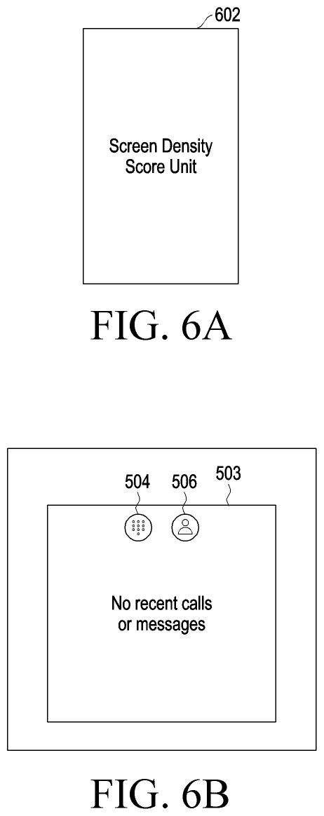

In a non-limiting example, FIG. 5B is a diagram illustrating an example scenario for calculating the mean touch object score according to various embodiments. In FIG. 5B, there are two UI objects 504 and 506 present on a UI screen 503. The UI screen 503 in this example is a call log screen. The mean touch score unit 502 further calculates the area of each of the UI objects 504 and 506. The mean touch score unit 502 calculates the weighted Arithmetic mean for the width and height of the UI objects 504 and 506 present on the call log screen. Based on the calculated weighted arithmetic mean, the mean touch score unit 502 gives scores in the range of 0 and 1. Therefore, the weighted arithmetic mean for the call log screen is 0.99, which may indicate that the UI screen is more complex because most of the call log screen is empty and the UI objects 504 and 506 area is very small with respect to the UI screen area Aₛ. The screen density score unit (Dₛ) of the electronic device 200 shown in FIG. 6A calculates the screen cluttered density score.

FIG. 6A is a diagram illustrating an example of a screen density score unit according to various embodiments. The screen density score unit 602 may be configured to first add the area of each of the UI objects to find total area covered by the total UI objects present on the UI screen 503. The screen density score unit 602 calculates screen cluttered density from the given Equation 3.

### Calculate Screen Cluttered Density:

$${D}_{s} = \frac{1}{{A}_{s}} {\sum }_{i = 1}^{N} {A}_{i} \qquad Equation 3$$

$$\begin{matrix}{A}_{s} \to Area of the screen \\ {A}_{i} \to Area of each clickable element on the screen\end{matrix}$$

In other words, the density score unit 602 calculates a ratio of the sum of the area covered by the total UI objects with the area Aₛ of the UI screen 503. The ratio defines how packed the UI screen is with the UI objects. In other words, the value of the ratio defines how dense the UI screen 503 is or the total area utilized by the UI objects on the UI screen 503. The screen density score unit 602 based on the ratio value assigns a screen density score in a predetermined scale range. Greater the ratio smaller the complexity of the UI screen 503.

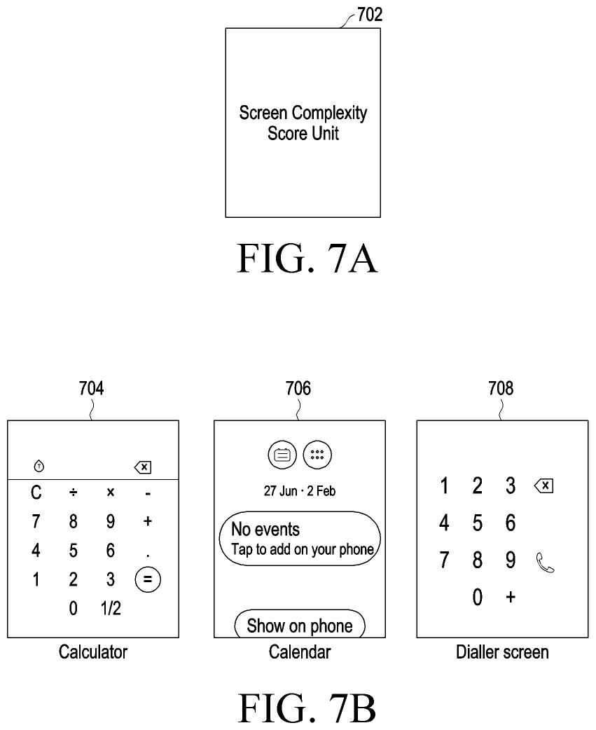

In an example implementation, the screen density score unit 602 as shown in FIG. 6B calculates the screen cluttered density. In a non-limiting example, the two UI objects are present on the UI screen 503. The screen density score unit 602 first adds the area of the UI object 504 and UI object 506. The screen density score unit 602 finds the cluttered density score using Equation 1. The screen density for the UI screen 503 e.g., the call log screen is 0.27. This may refer, for example, to the area utilized on the call log screen being very low for the given UI objects 504 and 506. The screen complexity score unit (Cₛ) as shown in FIG. 7A derives a screen complexity level of the UI screen 402.

FIG. 7A is a diagram illustrating an example of the screen complexity score unit according to various embodiments. The screen complexity score unit 702 may be configured to combine values of the clickable object score unit 401, the mean touch object score unit 502, and the screen density score unit 602 and compute a screen complexity screen using equation 4.

$${C}_{S} = \frac{{E}_{S} * {N}_{S}}{{D}_{S}} \qquad Equation 4.$$

In an example implementation, the screen complexity score unit 702 as shown in FIG. 7B computes the screen complexity score. In a non-limiting example, a calculator UI screen 704, a calendar UI screen 706, and a dialer screen 708 are considered. The screen complexity score unit 702 computes the screen complexity score using Equation 4. The screen complexity score for the calculator UI screen 704, the calendar UI screen 706, and the dialer screen 708 is shown in Table 1 as an example.

TABLE 1

| App Name | Nₛ | Eₛ | Dₛ | Cₛ |
|---|---|---|---|---|
| Calculator | 21 | 0.87 | 0.61 | 30.29 |
| Calendar | 4 | 0.71 | 0.99 | 5.56 |
| Dialer Screen | 14 | 0.86 | 0.62 | 19.57 |

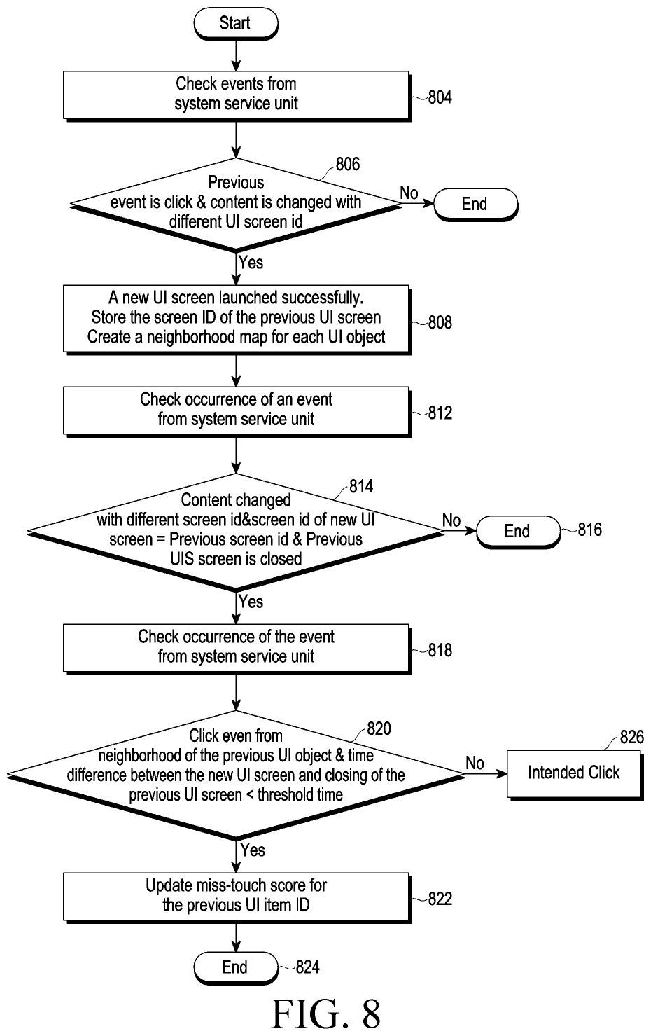

From the Table 1, the complexity score for the calculator UI screen 704 has a high score as compared to the calendar UI screen 706, and the dialer screen 708. This data is further sent to the aggregator unit 308. The user behavior unit (MTₛ) of the electronic device 200 as shown in FIG. 8 calculates a frequency of occurrence of an error while performing at least one of user operation on one of the UI objects present on the UI screen 503.

In an embodiment, the user behavior unit 306 may be configured to check the frequency of the occurrence of the error. For checking the frequency of the occurrence of the error, the user behavior unit 306 first determines user's first tap or click on any one of the UI objects present on the UI screen 503. For determining the user's first tap, the user behavior unit 306 obtains information related to the user's first tap from the system service unit 302. After determination, the user behavior unit 306 further stores total number of times the user presses a back button immediately after the first tap followed by tapping a neighboring UI object present on the screen. This information is also obtained from the system service unit 302. The user behavior unit 306 compares the number of times, the back button is pressed with a predefined threshold value for calculating the frequency of the error. In a non-limiting example, consider a user who taps on a UI object present on the UI screen 503, and presses back button immediately followed by tapping another UI object which is the neighboring UI object to the previous UI object. This behavior is recorded as a miss-touch. Or in other words, the total number of times the back button is pressed is compared with the predefined threshold time period. If the back button is pressed within the predefined threshold time period, it is termed as a miss-touch. Further, the user behavior unit 306 assigns an error score on a predefined scale range based on the number of the miss touch. This data is further sent to the aggregator unit 308.

In an embodiment, the calculation of the frequency of the occurrence of the error is explained through a flowchart illustrating an example of the user behavior.

FIG. 8 is a flowchart illustrating an example of the user behavior according to various embodiments. In FIG. 8, for checking total miss touch, the user behavior unit 306 at step 804 checks an event that occurred from the system service unit 302. In a non-limiting example, the event may be either clicking or touching an object out of a number of objects present on the UI screen. The user behavior unit 306 at step 806 checks whether the previous event was ‘click’ and content is changed with a different UI screen id. If ‘No’ then end. If ‘Yes,’ then move to step 808. At step 808, the user behavior unit 306 checks the successful launch of a new UI screen, from the system service unit 302. After successfully launching the new UI screen, the screen ID of the previous UI screen is stored, and a neighborhood map for each of the UI object is created. At step 812, the user behavior unit 306 again checks the occurrence of the event from the system service unit 302. At step 814, the user behavior unit 306 checks whether the content changed with the different screen id & screen id of the new UI screen is equal to the previous UI screen id. Further, the user behavior unit 306 checks whether the previous UI screen is closed. If ‘No’ then move to step 816. If ‘Yes,’ then move to step 818. At step 818, the user behavior unit 306 again checks the occurrence of the event from the system service unit 302. At step 820, the user behavior unit 306 checks that the click event from a neighborhood of the previous UI object & time difference between the opening of the new UI screen and the closing of the previous UI screen is less than a predefined threshold time. If ‘Yes,’ then move to step 822. At step 822, the user behavior unit 306 updates a mistouch score for the previous UI object. Then move to step 824. After step 820, if it is ‘No’, then the user behavior unit 306 determines that it is an intended click at step 826.

In an example embodiment, the user clicks on a first UI object present on the UI screen with a user's first screen id. The user then closes the first UI object that is opened, and further clicks on a second UI object present on the UI screen with a user's second screen id. But the second UI object is not neighboring to the first UI object. The user behavior unit 306 determines that the touch on the second UI object was intended. It was not mistakenly done. But, in a case, if the user clicks on the first UI object, and then immediately presses the back button and opens a neighboring third UI icon with a third user screen id within a predefined time. Then the user behavior unit 306 determines that the user touch was not intentional. It was touched mistakenly. Like this, the user behavior unit 306 identifies whether the touch was intended or not.

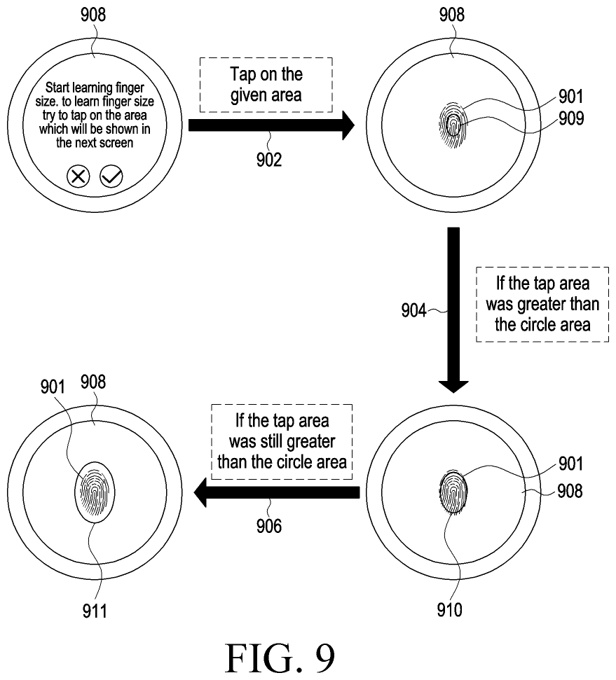

FIG. 9 is a diagram illustrating an example scenario for estimating user finger size according to various embodiments. Consider a scenario, where the user initially taps on a UI object present on the UI screen 908. The UI object comes on the UI screen 908. At step 902, the user behavior unit 306 determines the user's tap 901 on a predefined first circle area 909 of the UI screen 908. This information is obtained from the system service unit 302. The user behavior unit 306 also checks number of pixels covered during the user's tap 901 on the predefined first circle area 909 present on the UI screen 908. If the number of the pixels covered during the user's tap 901 is greater than a predefined number of pixels present in the first circle area 909, then the behavior unit 306 proceeds to step 904. At step 904, the behavior unit 306 checks with a second circle area 910. The second circle area 910 is a predefined circle area that has a larger area as compared to the first circle area 909. So, at this step the behavior unit 306 checks whether the number of pixels covered during the user's tap 901 is greater than a predefined number of pixels of the second circle area 910. If it is still greater, then the behavior unit 306 proceeds to step 906. At step 906, the behavior unit 306 checks with a third circle area 911. The third circle area 911 is a predefined circle area and has a larger area as compared to the second circle area 910. So, at this step, if the behavior unit 306 finds that the number of pixels covered during the user's tap 901 is still greater than the third circle area 911, then the behavior unit 306 further checks with a fourth circle area that has a larger area as compared to the third circle area 911. Like this, the user behavior unit 306 determines the size of the fingertip of the user. The determined data is further sent to the aggregator 308.

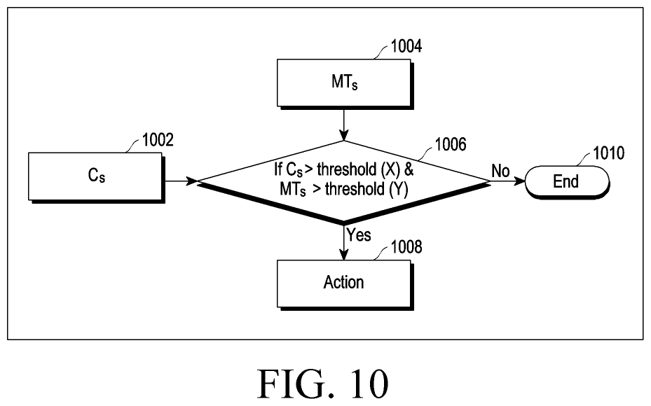

FIG. 10 is a diagram illustrating example operations of the aggregator unit according to various embodiments. From FIG. 10, the aggregator unit 308 at step 1002 checks the data related to the screen complexity obtained from the screen complexity score unit 702. The aggregator unit 308, at step 1004 checks the data related to the frequency of the occurrence of the error and the size of the fingertip of the user obtained from the user behavior unit 306. At step 1006 compares the obtained data of the screen complexity score unit 702 and the user behavior unit 306 with a predefined threshold value (x), and a predefined threshold value (y) stored in the database 210, respectively. The predefined threshold value (x) corresponds to a value of screen complexity, and the predefined threshold value (y) is a value for the occurrence of an error. The aggregator unit 308, at step 1006, checks, if Cs 702 is greater than the predefined threshold value (x) and MTs 306 is greater than the predefined threshold value (y). In case, they are greater, then the aggregator unit 308, at step 1008, sends instructions to the electronic device 200 to take predefined actions accordingly, and if not, the operation terminates at step 1010. The predefined actions may include altering the UI screen 402 with new UI screens that have enhanced UI objects. The other action may be sending instructions to the UI recommender unit 310. According to an embodiment, the UI recommender unit 310 may show output of the aggregator unit 308 to the developers or designers for designing the UI interface accordingly.

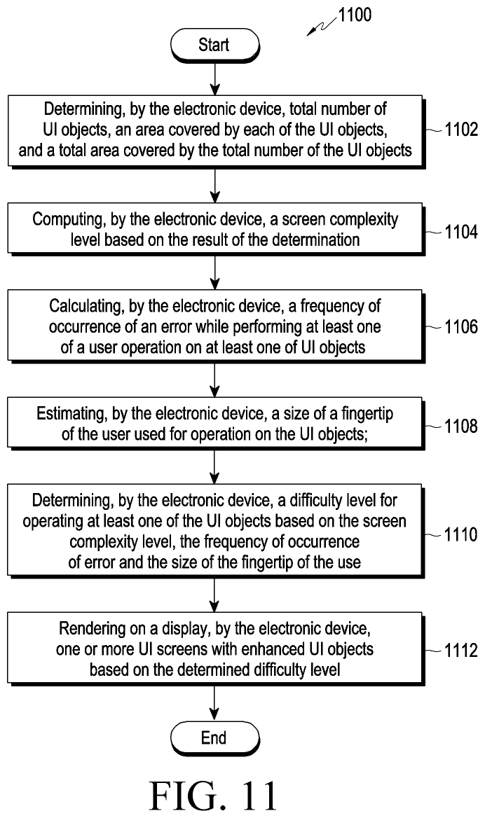

FIG. 11 is a flowchart illustrating example operations of the system for enhancing the operability of user interface (UI) of an electronic device according to various embodiments. According to an embodiment, the method 1100 is implemented in the electronic device 200 of the electronic device. The detailed explanation and implementation are being explained through FIGS. 4-10, thus for the sake of brevity, the same may not be repeated here. At step 1102, the method 1100 includes determining, by the electronic device 200, a total number of the UI objects, an area covered by each of the UI objects, and a total area covered by the total number of the UI objects. At step 1104, the method 1100 includes computing, by the electronic device 200, a screen complexity level based on the result of the determination. At step 1106, the method 1100 includes calculating, by the electronic device 200, a frequency of occurrence of an error while performing at least one of a user operation on at least one of UI objects. At step 1108, the method 1100 includes estimating, by the electronic device 200, a size of a fingertip of the user, used for operation on the UI objects. At step 1110, the method 1100 includes determining, by the electronic device 200, a difficulty level for operating at least one of the UI objects based on the screen complexity level, the frequency of occurrence of error, and the size of a fingertip of the user. At step 1112, the method 1100 includes rendering on a display, by the electronic device 200, one or more UI screens with enhanced UI objects based on the determined difficulty level.

According to an example, the method may further include calculating an area (Aₛ) of the screen of the electronic device 200, wherein the area of the screen is obtained from the data in the system service unit 302. The method may further include obtaining a predefined minimum size (Ai) value of each of the total number of UI objects from the data in the system service unit 302. The method may further include calculating the total number of UI objects based on the calculated area (Aₛ) of the screen and the obtained predefined minimum size (Ai) value. The method may further include determining, while the user is operating the screen of the electronic device 200, the total number of UI objects present on the screen based on the calculated area (Aₛ) of the screen and the obtained predefined minimum size (Ai) value. The method may further include comparing the total number of UI objects present on the screen with a predefined threshold value. The method may further include determining a screen complexity level based on a result of the comparison to obtain UI objects score in a predetermined scale range, wherein a maximum UI objects score defines the level of the complexity of the screen. The method may further include comparing the area (Aₛ) of the screen with the area covered by the each of the UI objects present in the screen, wherein the area covered by the each of the UI objects is calculated using a height and a width of one of UI object. The method may further include determining a level of emptiness on the screen based on the comparison. The method may further include determining a complexity level for using the screen based on the result of the comparison to obtain a mean touch score in a predetermined scale range, wherein a variation in size of the area of the each of the UI objects as compared to the total area of the screen defines the complexity of the screen. The method may further include calculating a ratio of the total area covered by the total number of the UI objects with the area (Aₛ) of the screen, wherein the total area covered by the total number of the UI objects is a sum of the area covered by the each of the UI objects. The method may further include determining an area utilization based on a result of the comparison to obtain a screen density score in a predetermined scale range, wherein the value of the ratio depicts denseness in the screen due to the presence of the total number of the UI objects. The method may further include combining the total number of the UI objects present on the screen and the sum of the area covered by the each of the UI objects. The method further includes calculating a ratio using the combined value and the calculated total area covered by the total number of the UI objects. The method may further include computing a level of complexity in the screen based on the calculation. The method further includes determining user's first tap on at least one of the UI objects present on the screen. The method may further include storing a number of times the user presses a back button immediately after the first tap followed by tapping a neighboring UI object present on the screen. The method may further include comparing the number of times, the back button is pressed with a predefined threshold value. The method may further include calculating the frequency of the occurrence of the error as a miss-touch based on the comparison. The method may further include determining the frequency of the occurrence of the error based on the result of the comparison. The method may further include obtaining a frequency error score in a predetermined scale range, wherein each time the number of the back button is pressed gives an error score or a miss-touch score. The method may further include storing the error score or the miss-touch score in a memory 204. The method may further include determining the user's first tap on a predefined area of the screen. The method may further include checking number of pixels covered during the user's first tap on the predefined area of the screen. The method may further include determining the size of the fingertip of the user in response to the checking. The method may further include obtaining an output result of the determined screen complexity level and the calculated frequency of the occurrence of the error. The method may further include comparing the obtained output result of the determined screen complexity level and the calculated frequency of the occurrence of the error with a predefined threshold value (x), and a predefined threshold value (y) respectively. The method may further include sending an instruction to the electronic device 200 to take one or more actions if the compared result is greater than the threshold value (x) and (y) respectively. The method may further include altering the UI screen with one or more UI screens with the enhanced objects.

Various example embodiments disclosed herein may be implemented using processing circuitry. For example, some example embodiments disclosed herein may be implemented using at least one software program running on at least one hardware device and performing network management functions to control the elements.

While specific language has been used to describe the disclosure, any limitations arising on account of the same are not intended. As would be apparent to a person in the art, various working modifications may be made to the method in order to implement the disclosure as taught herein.

The drawings and the forgoing description provide various example embodiments. Those skilled in the art will appreciate that one or more of the described elements may well be combined into a single functional element. Certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown, nor do all of the acts necessarily need to be performed. The acts that are not dependent on other acts may be performed in parallel with the other acts. The scope of the various example embodiments is not limited by these specific examples. Numerous variations, whether explicitly given in the disclosure or not, such as differences in structure, dimension, and use of material, are possible.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for managing a user interface (UI), by an electronic device, comprising:
determining a total number of UI objects on a screen of the electronic device, an area covered by each of the UI objects, and a total area covered by the UI objects;
obtaining a screen complexity level based on the determination;
obtaining a frequency of occurrence of an error while performing at least one user operation on at least one of the UI objects;
estimating a size of a fingertip used for operation on one or more of the UI objects;
determining a difficulty level for operating the at least one of the UI objects based on the screen complexity level, the frequency of occurrence of an error, and the size of the fingertip of the user; and
rendering on a display of the electronic device, one or more UI screens with at least one modified UI object based on the determined difficulty level.

2. The method of claim 1, wherein the total number of the UI objects present on the screen of the electronic device is determined based on data in a system service unit of the electronic device.

3. The method of claim 1, wherein for determining the total number of the UI objects, the method comprises:
obtaining an area of the screen of the electronic device;
obtaining a specified minimum size value of each of the UI objects; and
calculating the total number of the UI objects based on the obtained area of the screen and the obtained predefined minimum size value.

4. The method of claim 3, further comprising:
determining, while the user is operating the screen of the electronic device, the total number of the UI objects present on the screen based on the obtained area of the screen and the obtained predefined minimum size value;
comparing the total number of the UI objects present on the screen with a specified threshold value; and
determining the screen complexity level based on a result of the comparison to obtain UI objects score in a specified scale range, wherein a maximum UI objects score defines the level of the complexity of the screen.

5. The method of claim 1, further comprising:
comparing an area of the screen with the area covered by the each of the UI objects present in the screen, wherein the area covered by the each of the UI objects is calculated using a height and a width of each of the UI objects; and
determining a complexity level for using the screen based on the result of the comparison to obtain a mean touch score in a specified scale range, wherein a variation in size of the area of the each of the UI objects as compared to the area of the screen defines the complexity level of the screen.

6. The method of claim 1, further comprising:
calculating a ratio of the total area covered by the total number of the UI objects with respect to an area of the screen, wherein the total area covered by the total number of the UI objects is a sum of the area covered by the each of the UI objects; and
determining an area utilization based on the ratio of the total area covered by the total number of the UI objects with respect to the area of the screen to obtain a screen density score in a specified scale range, wherein the value of the ratio depicts denseness in the screen due to the total number of the UI objects.

7. The method of claim 1, wherein for obtaining the screen complexity level, the method comprises:
combining the total number of the UI objects present on the screen and a sum of the area covered by the each of the UI objects;
calculating a ratio using the combination of the total number of the UI objects present on the screen and the sum of the area covered by the each of the UI objects value, and a total area covered by the total number of the UI objects; and
computing a level of complexity in the screen based on the calculation.

8. The method of claim 1, wherein for obtaining the frequency of the occurrence of the error while performing the at least one user operation, the method comprises:
determining a first tap on of the UI objects present on the screen;
storing a number of times, a back button is pressed immediately after the first tap followed by tapping a neighboring UI object present on the screen;
comparing the number of times the back button is pressed with a specified threshold value; and
calculating the frequency of the occurrence of the error based on the comparison.

9. The method of claim 8, further comprising;
obtaining a frequency error score in a specified scale range, wherein each time the number of the back button is pressed gives an error score or a miss-touch score; and
storing the error score or the miss-touch score in a memory.

10. The method of claim 1, wherein for estimating the size of the fingertip of the user, the method comprises:
determining a first tap on a specified area on the screen;
checking a number of pixels covered by the first tap on the specified area of the screen; and
determining the size of the fingertip based on the checked number of pixels.

11. The method of claim 1, wherein after determining the difficulty level for operating at least one of the UI objects, the method comprises:
comparing the obtained screen complexity level and the obtained frequency of the occurrence of the error with a first specified threshold value, and a second specified threshold value respectively; and
performing one or more actions based on the obtained screen complexity level being greater than the first threshold value, and the obtained frequency of the occurrence of the error being greater than the second threshold value.

12. The method of claim 11, wherein the one or more action includes altering of the UI screen with the one or more UI screens with the at least one modified object.

13. An electronic device, comprising:
memory storing instructions; and
at least one processor, comprising processing circuitry, coupled with the memory, wherein the instructions, when executed by the at least one processor, individually and/or collectively, cause the electronic device to perform operations comprising:
determining a total number of UI objects on a screen of the electronic device, an area covered by each of the UI objects, and a total area covered by the UI objects;
obtaining a screen complexity level based on the determination;
obtaining a frequency of occurrence of an error while performing at least one user operation on at least one of the UI objects;
estimating a size of a fingertip used for operation on one or more of the UI objects;
determining a difficulty level for operating the at least one of the UI objects based on the screen complexity level, the frequency of occurrence of an error, and the size of the fingertip of the user; and
rendering on a display of the electronic device, one or more UI screens with at least one modified UI object based on the determined difficulty level.

14. The electronic device of claim 13, wherein the total number of the UI objects present on the screen of the electronic device is determined based on data in a system service unit of the electronic device.

15. The electronic device of claim 13, wherein for determining the total number of the UI objects, the operations comprise:
obtaining an area of the screen of the electronic device;
obtaining a specified minimum size value of each of the UI objects; and
calculating the total number of the UI objects based on the obtained area of the screen and the obtained predefined minimum size value.

16. The electronic device of claim 15, wherein the operations further comprise:
determining, while the user is operating the screen of the electronic device, the total number of the UI objects present on the screen based on the obtained area of the screen and the obtained predefined minimum size value;
comparing the total number of the UI objects present on the screen with a specified threshold value; and
determining the screen complexity level based on a result of the comparison to obtain UI objects score in a specified scale range, wherein a maximum UI objects score defines the level of the complexity of the screen.

17. The electronic device of claim 13, wherein the operations further comprise:
comparing an area of the screen with the area covered by the each of the UI objects present in the screen, wherein the area covered by the each of the UI objects is calculated using a height and a width of each of the UI objects; and
determining a complexity level for using the screen based on the result of the comparison to obtain a mean touch score in a specified scale range, wherein a variation in size of the area of the each of the UI objects as compared to the area of the screen defines the complexity level of the screen.

18. The electronic device of claim 13, wherein the operations further comprise:
calculating a ratio of the total area covered by the total number of the UI objects with respect to an area of the screen, wherein the total area covered by the total number of the UI objects is a sum of the area covered by the each of the UI objects; and
determining an area utilization based on the ratio of the total area covered by the total number of the UI objects with respect to the area of the screen to obtain a screen density score in a specified scale range, wherein the value of the ratio depicts denseness in the screen due to the total number of the UI objects.

19. The electronic device of claim 13, wherein for obtaining the screen complexity level, the operations comprise:
combining the total number of the UI objects present on the screen and a sum of the area covered by the each of the UI objects;
calculating a ratio using the combination of the total number of the UI objects present on the screen and the sum of the area covered by the each of the UI objects value, and a total area covered by the total number of the UI objects; and
computing a level of complexity in the screen based on the calculation.

20. A non-transitory computer-readable storage medium storing instructions which, when executed by at least one processor, comprising processing circuitry, of an electronic device, individually and/or collectively, cause the electronic to perform operations, the operations comprising:
determining a total number of UI objects on a screen of the electronic device, an area covered by each of the UI objects, and a total area covered by the UI objects;
obtaining a screen complexity level based on the determination;
obtaining a frequency of occurrence of an error while performing at least one user operation on at least one of the UI objects;
estimating a size of a fingertip used for operation on one or more of the UI objects;
determining a difficulty level for operating the at least one of the UI objects based on the screen complexity level, the frequency of occurrence of an error, and the size of the fingertip of the user; and
rendering on a display of the electronic device, one or more UI screens with at least one modified UI object based on the determined difficulty level.
